(19) United States
(12) Patent Application Publication
(10) Pub. No.: US 2016/0379751 A1
(43) Pub. Date: Dec. 29, 2016

(54) PULSE TRANSFORMER

(71) Applicant: TDK Corporation, Tokyo (JP)

(72) Inventors: Syun ASHIZAWA, Tokyo (JP); Nobuo TAKAGI, Tokyo (JP); Setu TSUCHIDA, Tsuruoka-city (JP); Tasuku MIKOGAMI, Tokyo (JP)

(21) Appl. No.: 15/192,907

(22) Filed: Jun. 24, 2016

(30) Foreign Application Priority Data
Jun. 26, 2015 (JP) 2015-128959

(51) Int. Cl. H01F 27/28; H01F 27/255

(52) U.S. Cl. CPC H01F 27/2823; H01F 27/255

(57) ABSTRACT

A pulse transformer has a winding core and a coil portion formed around an outer circumference of the winding core and composed of a primary coil and a secondary coil. The primary coil has a first wire and a second wire. The secondary coil has a third wire and a fourth wire. The coil portion includes a first layer formed by the first wire, a second layer positioned around an outer circumference of the first layer and formed by the third wire, a third layer positioned around an outer circumference of the second layer and firmed by the fourth wire, and a fourth layer positioned around an outer circumference of the third layer and formed by the second wire.

### BACKGROUND OF THE INVENTION

1. Field of the Invention

The present invention relates to a pulse transformer used for transmission of pulse signals through LAN cables or so, for example.

2. Description of the Related Art

When a device such as a personal computer is connected to a network such as a LAN and a telephone network, it is necessary to protect the device from the entry of Electrostatic Discharge (ESD) and high voltage via a cable. Thus, a pulse transformer is used in a connector that constitutes a connection point between the cable and the device.

Pulse transformers conventionally used are manufactured by winding a primary coil and a secondary coil around a donut magnetic core (toroidal core), and have a property of transmitting only an AC component (pulse) of voltage applied to the primary coil to the secondary coil. Since a DC component is not transmitted to the secondary coil, the pulse transformers are able to interrupt ESD and high voltage.

Instead of the toroidal cores, drum cores have been used due to demand for miniaturization and surface mount of the pulse transformers. Such a pulse transformer is referred to as a surface-mount pulse transformer, and Patent Document 1 discloses an example thereof.

By the way, when a pulse transformer for LAN etc. is used together with signal generation Ic, this kind of pulse transformer may be required to have a magnitude of inductance (L value) for matching with the signal generation Ic.

Patent Document 1: Japanese Patent Application Laid-open No. 2009-21558

### SUMMARY OF THE INVENTION

However, a bifilar-winding pulse transformer as shown in Patent Document 1 tends to have a deteriorated performance if a three or more layer multilayer winding is formed around an outer circumference of a drum core, and thus has a difficult problem in simultaneously achieving increase in inductance and downsizing.

The present invention has been achieved in consideration of the circumstances. It is an object of the invention to provide a pulse transformer simultaneously enabling to increase inductance and downsizing.

That is, a pulse transformer according to the first aspect of the present invention comprises:

a winding core; and

a coil portion formed around an outer circumference of the winding core and composed of a primary coil and a secondary coil,

wherein;

the primary coil has a first wire and a second wire;

the secondary coil has a third wire and a fourth wire; and

the coil portion includes:

a first layer formed by the first wire;

a second layer positioned around an outer circumference of the first layer and formed by the third wire;

a third layer positioned around an outer circumference of the second layer and formed by the fourth wire; and

a fourth layer positioned around an outer circumference of the third layer and formed by the second wire.

Also, a pulse transformer according to the second aspect of the present invention comprises:

a winding core; and

a coil portion formed around an outer circumference of the winding core and composed of a primary coil and a secondary coil,

wherein:

the primary coil has a first wire and a second wire;

the secondary coil has a third wire and a fourth wire; and

the coil portion includes:

a first layer formed by the third wire;

a second layer positioned around an outer circumference of the first layer and formed by the first wire;

a third layer positioned around an outer circumference of the second layer and formed by the second wire; and

a fourth layer positioned around an outer circumference of the third layer and formed by the fourth wire.

In the pulse transformer according to the present invention, the first layer and the fourth layer composed of the primary coil or the secondary coil are arranged to sandwich the second layer and the third layer composed of the secondary coil or the primary coil, which can prevent increase in inter-line capacity at the time of multilayering, which is a problem in bifilar winding. This allows the pulse transformer according to the present invention to simultaneously achieve increase in inductance and downsizing while maintaining property of insertion loss (IL) or so.

Note that, a winding start and a winding end of the respective first, second, third, and fourth layers may have winding turbulence.

### BRIEF DESCRIPTION OF THE DRAWINGS

FIG. 1 is a perspective view of a pulse transformer according to First Embodiment of the present invention.

FIG. 2 is a schematic half cross sectional view of a coil portion wound around a winding core of the pulse transformer shown in FIG. 1.

FIG. 3 is an equivalent circuit diagram of the pulse transformer shown in FIG. 1.

FIG. 4 is a schematic half cross sectional view of a coil portion wound around a winding core of a pulse transformer according to Second Embodiment of the present invention.

FIG. 5 is a perspective view of a pulse transformer according to Third Embodiment of the present invention.

### DESCRIPTION OF THE PREFERRED EMBODIMENTS

Hereinafter, the present invention will be described with reference to Embodiments shown in the drawings.

### First Embodiment

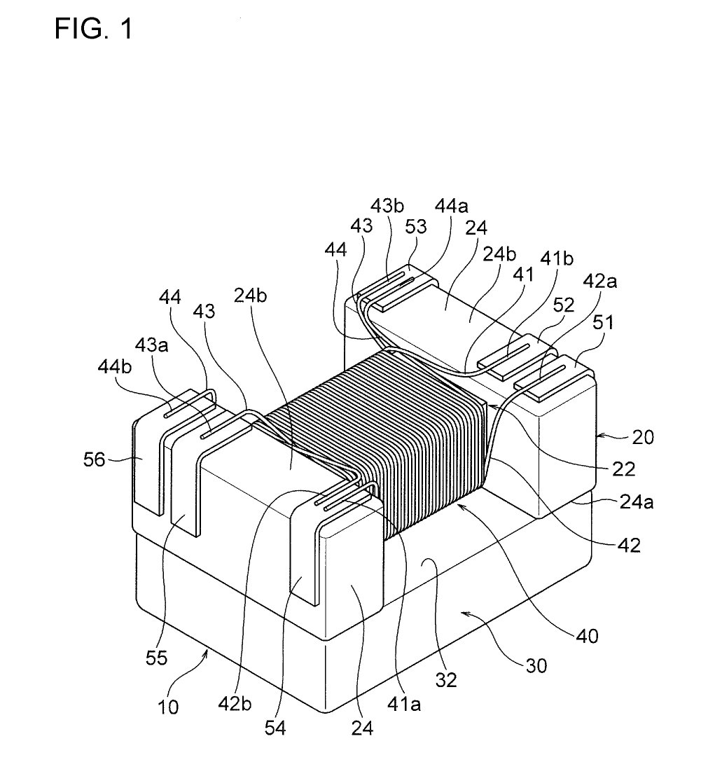

As shown in FIG. 1, a pulse transformer according to one embodiment of the present invention consists of a surface-mount coil component 10. The coil component 10 includes a first core 20 of a drum core, a plate second core 30, and a coil portion 40 wound around a winding core 22 of the first core 20.

In the description of the coil component 10, please note the following: the X-axis direction is a direction that is within a surface parallel to a mounting surface on which the coil component 10 is mounted and is parallel to the winding axis of the winding core 22 of the first core 20; the Y-axis direction is a direction that is within a surface parallel to the mounting surface similarly to the X-axis direction; and the Z-axis direction is a normal direction of the mounting surface.

The coil component 10 has an outside dimension of 3.2 mm in width×2.8 mm in height×3.2 mm in length, for example, but is not limited to have this size.

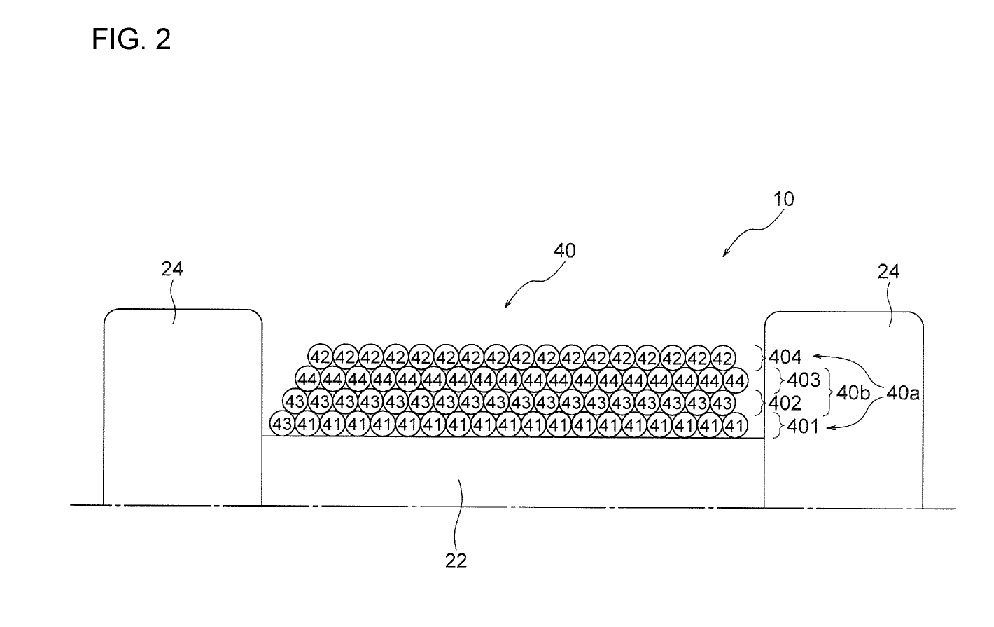

A core of the coil component 10 consists of combination of the first core 20 and the second core 30. The first core 20 has the bar-shaped winding core 22 (see FIG. 2) and a pair of flanges 24 and 24 as a pair of core ends provided at both ends of the winding core 22.

The flanges 24 have an outer shape of a substantially rectangular parallelepiped shape, and a pair of the flanges 24 is arranged to be substantially parallel to each other with a predetermined distance in the X-axis direction. The winding core 22 is connected to central areas of respective surfaces facing each other of a pair of the flanges 24, which connects a pair of the flanges 24. In this embodiment, the winding core 22 has a cross section of rectangle, but the cross section may be circular and is not limited.

The second core 30 is a plate core and has an outer shape of a substantially rectangular parallelepiped whose shortest sides are along the Z-axis direction. The second core 30 has a shape of a substantial rectangle whose longer sides are along X-axis direction when viewed from a normal direction of the bottom surface (the Z-axis direction), but may be square or other shapes. A top surface 32 of the second core 30 faces bottom surfaces 24a of the flanges 24 located at both ends in the X-axis direction and are fixed on the bottom surfaces 24a by adhesive such as thermosetting resin, for example. This allows the second core 30 to form a magnetic path continuing to the first core 20.

Terminal parts 51 to 56 are provided with each flange 24 of the first core 20. The terminal parts 51 to 56 consist of fittings having a substantially L-shaped outer shape, and at least a part of each of the terminal parts 51 to 56 is attached on mounting surfaces 24b of the flanges 24. Note that, the mounting surfaces 24b of the flanges 24 are tap surfaces in the Z-axis direction located on the other side of the bottom surfaces 24a facing the top surface 32 of the second core 30.

The three terminal parts 51 to 53 are attached on one of the flanges 24, and the other three terminal parts 54 to 56 are attached on the other flange 24. Intervals of adjacent terminal parts are not regular. That is, an interval between the terminal part 52 and the terminal part 53 is configured to be wider than an interval between the terminal part 51 and the terminal part 52, and an interval between the terminal part 54 and the terminal part 55 is configured to be wider than an interval between the terminal part 55 and the terminal part 56.

The coil portion 40 is formed around the winding core 22 of the first core 20. The coil portion 40 consists of four wires 41 to 44. That is, as shown in FIG. 2, the coil portion 40 is composed of a primary coil 40a and a secondary coil 40b. The primary coil 40a has the first wire 41 and the second wire 42. The secondary coil 40b has the third wire 43 and the fourth wire 44. The first to fourth wires 41 to 44 are composed of core material of good conductor coated with an insulating film to form a coated wire, for example, and are wound around the winding core 22 in a four-layer structure mentioned below.

As shown in FIG. 2, the coil portion 40 having the four-layer structure has a first layer 401, a second layer 402, a third layer 403, and a four layer 404, and the first to fourth layers 401 to 404 are arranged from outside the winding core 22 to the outer diameter direction. The first layer 401 positioned around an outer circumference of the winding core 22 is form td by the first wire 41. Note that at both ends of a winding start and a winding end in the first layer 401 (both ends in the X-axis direction), part of the other wires 42 to 44, such as the third wire 43, may be positioned in the first layer 401 due to influence of winding turbulence etc.

The second layer 402 positioned around an outer circumference of the first layer 401 is formed by the third wire 43. The third layer 403 further positioned around an outer circumference of the second layer 402 is formed by the fourth wire 44. Note that, at both ends of a winding start and a winding end in the second layer 402 and the third layer 403 (both ends in the X-axis direction), part of the other wires 41 to 44 other than the wires 43 and 44 forming the layers 402 and 403 may be positioned in the second layer 402 or the third layer 403 due to influence of winding turbulence etc. The fourth layer 404 positioned around an outer circumference of the third layer 403 is formed by the second wire 42.

With this, in the coil portion 40, the primary coil 40a is composed of the first wire 41 configuring the innermost first layer 401 and the second wire 42 configuring the outermost fourth layer 404, and the secondary coil 40b is composed of the third wire 43 and the fourth wire 44 configuring the second layer 402 and the third layer 403 sandwiched by the first layer 401 and the fourth layer 404. In the coil portion 40, the third wire 43 and the fourth wire 44 configuring the secondary coil 40b are radially sandwiched by the first wire 41 and the second wire 42 configuring the primary coil 40a.

Each turn of the first wire 41 forming the first layer 401 is closely in contact with the first wire 41 before one turn and after one turn with respect to the X-axis direction, which is a forming direction of the first layer 401. Also, the first wire 41 forming the first layer 401 is closely in contact with the winding core 22 at the inner circumference side and is closely in contact with the third wire 43 forming the second layer 402 at the outer circumference side. Similarly, each turn of the third wire 43 forming the second layer 402 is closely in contact with the third wire 43 before one turn and after one turn with respect to the X-axis direction, which is a forming direction of the second layer 402. Also, the third wire 43 forming the second layer 402 is closely in contact with the first wire 41 forming the first layer 401 at the inner circumference side and is closely in contact with the fourth wire 44 forming the third layer 403 at the outer circumference side.

Each turn of the fourth wire 44 forming the third layer 403 is closely in contact with the fourth wire 44 before one turn and after one turn with respect to the X-axis direction, which is a forming direction of the third layer 403. Also, the fourth wire 44 forming the third layer 403 is closely in contact with the third wire 43 forming the second layer 402 at the inner circumference side and is closely in contact with the second wire 42 forming the fourth layer 404 at the outer circumference side. Similarly, each turn of the second wire 42 forming the fourth layer 404 is closely in contact with the second wire 42 before one turn and after one turn with respect to the X-axis direction, which is a forming direction of the fourth layer 404. Also, the second wire 42 forming the fourth layer 404 is closely in contact with the fourth wire 44 forming the third layer 403 at the inner circumference side.

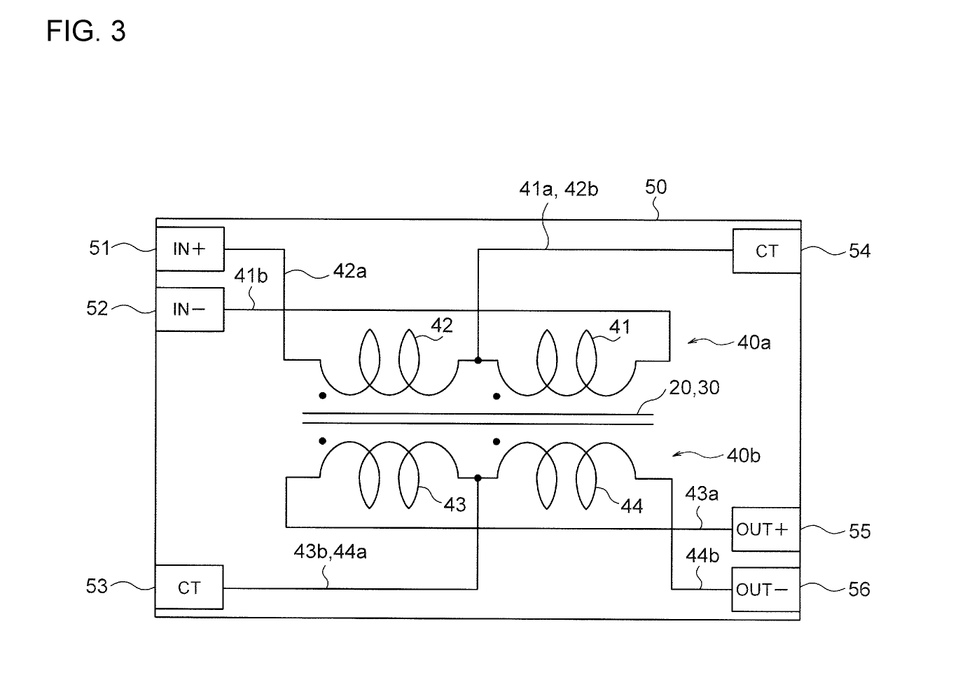

As shown in FIG. 1 and FIG. 3, wire ends 41a and 41b of the first wire 41 are respectively connected to the terminal parts 54 and 52, wire ends 42a and 42b of the second wire 42 are respectively connected to the terminal parts 51 and 54, and wire ends 43a and 43b of the third wire 43 are respectively connected to the terminal parts 55 and 53. Also, wire ends 44a and 44b of the fourth wire 44 are respectively connected to the terminal ends 53 and 56.

As shown in FIG. 3, the terminal parts 51 and 52 are respectively used as a positive-side terminal IN+ and a negative-side terminal IN− of balanced inputs. Also, the terminal parts 55 and 56 are respectively used as a positive-side terminal OUT+ and a negative-side terminal OUT− of balanced outputs. The terminal parts 53 and 54 are respectively used an input-side intermediate tap CT and an output-side inter mediate tap CT. The first and second wires 41 and 42 constitute a primary winding (primary coil 40a) of the pulse transformer, and the third and fourth wires 43 and 44 constitute a secondary winding (secondary coil 40b) of the pulse transformer.

Note that, the first to fourth wires 41 to 44 have any diameter, but preferably have a diameter of 0.02 to 0.1 mm.

When manufacturing the coil component 10, the drum first core 20 on which the terminal parts 51 to 56 are placed and the first to fourth wires 41 to 44 are firstly prepared. The first core 20 is formed of molding and sintering a magnetic material having a relatively high permeability, such as Ni—Zn ferrite and Mn—Zn ferrite, or a magnetic powder composed of a metal magnetic substance or so, for example. The metal terminal parts 51 to 56 are attached on the flanges 24 of the first core 20 by adhesion or so. Note that, the terminal parts 51 to 56 may be placed on the flanges 24 by forming a conductive film on the first core 20 with such as printing and plating and firing the conductive film.

The first to fourth wires 41 to 44 can be obtained by covering a core material made of a good conductor such as copper (Cu) with an insulating material made of imide-modified polyurethane or so, and further covering its outermost surface with a thin resin film such as polyester, for example. The first core 20 on which the terminal parts 51 to 56 are mounted and the first to fourth wires 41 to 44 prepared are positioned in a winding machine, and the first to fourth wires 41 to 44 are wound around the winding core 22 of the first core 20 in a predetermined order.

In the present embodiment, first, the first wire 41 shown in FIG. 2 is wound around the outer circumference of the winding core 22 to form the first layer 401, and then the third wire 43 is wound around the outer circumference of the first layer 401 to form the second layer 402. Further, the fourth wire 44 is wound around the outer circumference of the second layer 402 to form the third layer 403, and finally the second wire 42 is wound around the outer circumference of the third layer 403 to form the fourth layer 404. After forming the first to fourth layers 401 to 404, ends of the first to fourth wires 41 to 44 are fixed to the terminal parts 51 to 56 by soldering or so.

Next, the plate second core 30 is prepared and joined to the first core 20 wound by the coil portion 40. Similarly to the first core 20, the second core 30 is formed of a sintering body or a molding body of a magnetic material made of Ni—Zn ferrite, Mn—Zn ferrite, a metal magnetic body, or the like.

In the coil component 10 as the pulse transformer according to the present embodiment, the coil portion 40 formed around the winding core 22 has the first to fourth layers 401 to 404 formed by being overlapping wound around the outer circumferences in each layer and has four or more layer multilayer structure, and thereby as pulse transformer that is small and has high inductance can be achieved. Further, after forming each layer by separate coils, the third wire 43 and the fourth wire 44 configuring the secondary coil 40b are radially sandwiched by the first wire 41 and the second wire 42 configuring the primary coil 40a. In the coil component 10, it is thus possible to obtain a pulse transformer that prevents increase in inter-line capacity associated with multilayering as seen in bifilar winding, is excellent in property of insertion loss, and simultaneously achieves downsizing and high inductance.

In the coil component 10 of this embodiment, prevention of increase in inter-line capacity particularly reduces insertion loss in a high frequency region, which allows reduction in signal attenuation amount at high frequency and an accurate long-distance transmission of high-speed data signals.

Since the third wire 43 and the fourth wire 44 configuring the secondary coil 40b are radially sandwiched by the first wire 41 and the second wire 42, the coil component 10 prevents variation in wire length and inductance between the primary coil 40a and the secondary coil 40b, demonstrates excellent balance characteristics not inferior to bifilar winding, and is excellent in noise elimination characteristics.

### Second Embodiment

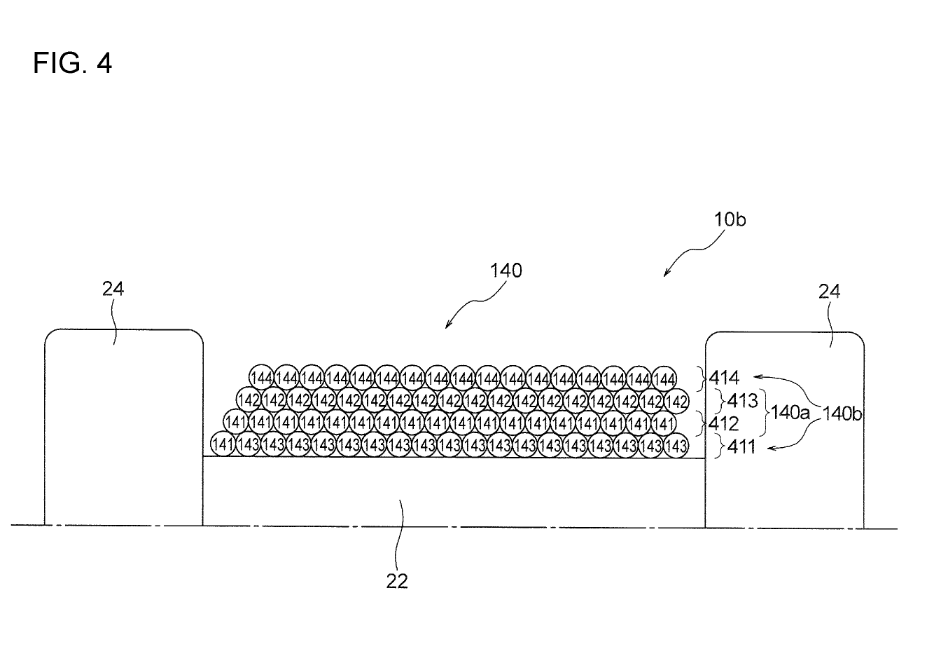

In a coil component 10b as a pulse transformer of Second Embodiment shown in FIG. 4, a primary coil 140a and a secondary coil 140b of a coil portion 140 are arranged reversely with respect to the coil component 10 shown in FIG. 2, but other structure is the same as the coil component 10. That is, the coil portion 140 is composed of the primary coil 140a and the secondary coil 140b, the primary coil 140a has a first wire 141 and a second wire 142, and the secondary coil 140b has a third wire 143 and a fourth wire 144.

As shown in FIG. 4, the coil portion 140 having the four-layer structure has a first layer 411, a second layer 412, a third layer 413, and a four layer 414, and the first to fourth layers 411 to 414 are arranged from outside a winding core 22 to the outer diameter direction. The first layer 411 positioned around an outer circumference of the winding core 22 is formed by the third wire 143, the second layer 412 positioned around an outer circumference of the first layer 411 is formed by the first wire 141, the third layer 413 positioned around an outer circumference of the second layer 412 is formed by the second wire 142, and the fourth layer 414 positioned around an outer circumference of the third layer 413 is formed by the fourth wire 144.

With this, in the coil portion 140, the secondary coil 140b is composed of the third wire 143 configuring the innermost first layer 411 and the fourth wire 144 configuring the outermost fourth layer 414, and the primary coil 140a is composed of the first wire 141 and the second wire 142 configuring the second layer 412 and the third layer 413 sandwiched by the first layer 411 and the fourth layer 414. Thus, the coil component 10b, where the first wire 141 and the second wire 142 configuring the primary coil 140a are radially sandwiched by the third wire 143 and the fourth wire 144 configuring the secondary coil 140b, demonstrates the same effect as the coil component 10 according to First Embodiment.

### Third Embodiment

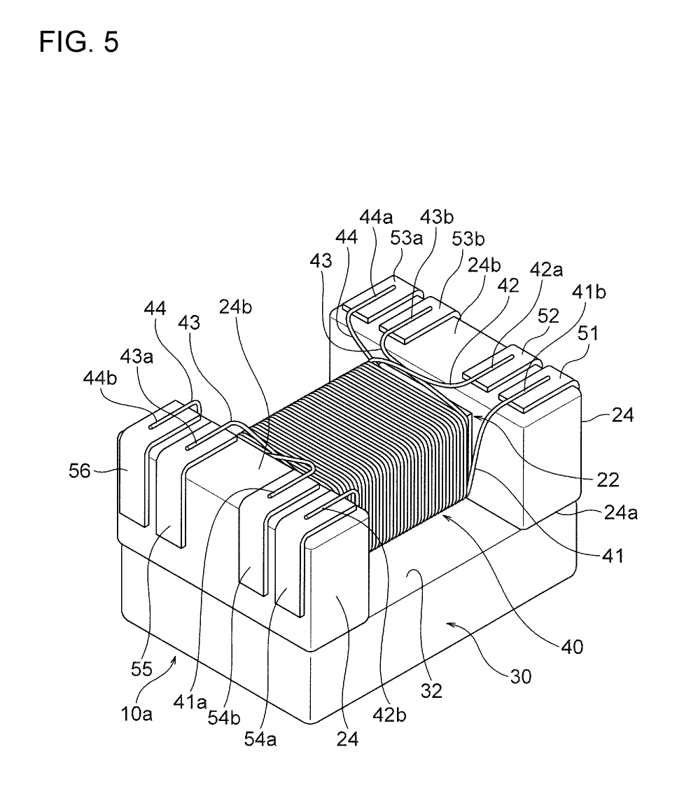

A coil component 10a as a pulse transformer of Third Embodiment shown in FIG. 5 is different from a coil component 10 of First embodiment in that four terminal parts are placed on both sides of flanges 24 (i.e., eight terminal parts in total), but the other features are the same as those of First Embodiment. Terminal parts 53a and 53b of the coil component 10a correspond to a terminal part 53 of the coil component 10 of First Embodiment, and terminal parts 54a and 54b of the coil component 10a correspond to a terminal part 54 of the coil component 10.

In the coil component 10a, an electrical connection between a wire end 43b and a wire end 44a and an electrical connection between a wire end 41a and a wire end 42b are carried out through a wiring pattern on a wiring board on which the coil component 10a is mounted. The other features and effects of the coil component 10a according to this embodiment are the same as those of First Embodiment, and detailed description thereof is omitted.

Note that, the present invention is not limited to the above-mentioned embodiments and can be changed variously within the scope thereof.

For example, the first core 20 is not limited to have a drum shape shown in the embodiments, but may have any shape including a pair of core ends at both ends of the winding core, such as U-shaped. Two flanges 24 of the first core 20 may have the same or different shape.

In the above-mentioned embodiment, the primary coil 40a of the coil portion 40 consists of the two wires 41 and 42, and the secondary coil 40b thereof consists of the two wires 43 and 44, but the first wire 41 and the second wire 42 may consist of a continuous one wire turned back at the terminal part 54. Also, the third wire 43 and the fourth wire 44 may consist of a continuous one wire turned back at the terminal part 53.

Further, the terminal parts 53 and 54 are used in the above-mentioned embodiments, but may be omitted depending on usage. That is, the terminal parts 53 and 54 used as an input-side intermediate tap CT and an output-side intermediate tap CT, as shown in FIG. 3, may be removed, and a pulse transformer may be employed. In this case, the pulse transformer is employed using only two wires.

Further, in the present embodiment, the number of wires used during winding may be reduced by devising a winding method of wire for the winding core 22. For example, after forming a plurality of layers (e.g. all of the first to fourth layers 401 to 404) contained in the coil portion 40 of the winding core 22 using one wire, a boundary between the primary coil 40a and the secondary coil 40b of the coil portion 40 may be disconnected to separate the primary coil 40a and the secondary coil 40b.

In the embodiments mentioned above, the first wire 41 and the second wire 42 configuring the primary coil 40a may be reversely positioned in each figure including the circuit diagram of FIG. 3. The third wire 43 and the fourth with 44 configuring the secondary coil 40b may be also reversely positioned. That is, the first wire and the second wire do not mean a positional relation in the primary coil, but a wire respectively configuring any two coils configuring the primary coil. Similarly, the third wire and the fourth wire do not mean a positional relation in the secondary coil, but a wire respectively configuring any two coils configuring the secondary coil. In the circuit shown in FIG. 3, it is thus also possible to arrange the third wire 43 at a position shown by a sign 44 and arrange the fourth wire 44 at a position shown by a sign 43.

In the embodiments mentioned above, as shown in FIG. 2, the first to fourth wires 41 to 44 are densely wound in the X-axis direction so that wires before and after each turn contact with each other, but are not limited to be arranged in this way. For example, a region where the first to fourth wires 41 to 44 are densely wound and a region where the first to fourth wires 41 to 44 are coarsely wound may be formed along the X-axis direction around the outer circumference of the winding core 22. Further, a region where the first to fourth wires 41 to 44 are not wound may be formed in part of the X-axis direction.

### NUMERICAL REFERENCES

10, 10a, 10b . . . coil component
20 . . . first core
22 . . . winding core
24 . . . flange (core end)
30 . . . second core
40 . . . coil portion
40a, 140a . . . primary coil
40b, 140b . . . secondary coil
41 . . . first wire
42 . . . second wire
43 . . . third wire
44 . . . fourth wire
401, 411 . . . first layer
402, 412 . . . second layer
403, 413 . . . third layer
404, 414 . . . fourth layer

1. A pulse transformer, comprising:
a winding core; and
a coil portion formed around an outer circumference of the winding core and composed of a primary coil and a secondary coil,
wherein:
the primary coil has a first wire and a second wire;
the secondary coil has a third wire and a fourth wire; and
the coil portion includes:
a first layer formed by the first wire;
a second layer positioned around an outer circumference of the first layer and formed by the third wire;
a third layer positioned around an outer circumference of the second layer and formed by the fourth wire; and
a fourth layer positioned around an outer circumference of the third layer and formed by the second wire.

2. A pulse transformer, comprising:
a winding core; and
a coil portion formed around an outer circumference of the winding core and composed of a primary coil and a secondary coil,
wherein:
the primary coil has a first wire and a second wire;
the secondary coil has a third wire and a fourth wire; and
the coil portion includes:
a first layer formed by the third wire;
a second layer positioned around an outer circumference of the first layer and formed by the first wire;
a third layer positioned around an outer circumference of the second layer and formed by the second wire; and
a fourth layer positioned around an outer circumference of the third layer and formed by the fourth wire.
